(19) United States
(12) Patent Application Publication
(10) Pub. No.: US 2006/0053931 A1
(43) Pub. Date: Mar. 16, 2006

(54) BTSI with lead frame switch

(76) Inventor: Weston C. Bye, Grand Blanc, MI (US)

Correspondence Address: Thomas N.Young;Young & Basile, P.C., Suite 624, 3001 W. Big Beaver Road, Troy, MI, 48084, US

(21) Appl. No.: 10/916,862

(22) Filed: Aug. 12, 2004

(51) Int. Cl. G05G 5/00

(52) U.S. Cl. 74/473.21

(57) ABSTRACT

A brake-shift-ignition interlock includes a releasable shifter lock containing a slidable blocker pin associated with the shifter mechanism, a solenoid having an armature which normally resides in a non-centered position when the releasable shifter lock is in the locked or blocking position. Energization of the solenoid by means of a lead frame disposed within the BTSI housing pivots a control arm to unblock the shifter lock. Sliding movement of a blocker pin operates a pair of sliding contacts bearing on the lead frame to open the circuit to the solenoid coil and close the circuit to an ignition key lock. A leaf spring disposed flexibly between the BTSI housing and the control arm eliminates the need for mechanical stops and returns the solenoid armature to the relaxed, non-centered position as soon as the shift lever is returned to the “PARK” position.

### FIELD OF THE INVENTION

This invention relates to automotive brake-shift interlock systems commonly called BTSI's and more particularly to a low-noise releasable shifter lock for use in such systems.

### BACKGROUND OF THE INVENTION

Brake-shift interlocks and brake-shift-ignition interlocks came into common use in automobiles sold for use within the United States to address problems of unintended vehicle acceleration. The objective of such systems is to prevent automatic transmissions from being shifted out of the “PARK” condition when the engine is running until such time as the driver of the automobile places a foot on the brake pedal and depresses the brake pedal sufficiently to close the brake light switch.

This objective is accomplished through the use of an electromagnetic device such as a solenoid which locks the shifter detent until depression of the brake pedal changes the state of the device. One prior art system is disclosed in U.S. Pat. No. 5,938,562 to Charles D. Withey.

It is a well-known fact that the operation of the electromagnetic device in the BTSI system produces audible noise. This is typically the result of energizing the solenoid coil and advancing the armature until it strikes a pole piece or other mechanical stop. Most BTSI's also generate noise when the armature is returned to its rest position by a spring and the armature or some associated mechanical component is urged against a positive stop. Noise can also be created by the armature and in some cases a spring impacting or dragging along the inside of the solenoid coil bobbin. Attempts to reduce noise typically take the form of rubber bumpers or pneumatic or viscous damping.

### SUMMARY OF THE INVENTION

An objective of the present invention is to provide a low-noise releasable shifter lock for use in BTSI systems. Noise is reduced or eliminated through the elimination of mechanical stops, including armature pole pieces, in favor of a housing and a spring within the housing which, in the relaxed position, places the shifter lock in a rest condition and places the armature of the electromagnetic device attached to the housing in a non-centered position within the coil geometry which corresponds to the rest condition. Subsequent energization of the electromagnet device such as by depressing the brake pedal causes the magnetic portion of the armature to move toward a centered position within the coil structure thereby flexing the spring. When current is later shut off to the coil, the spring returns the armature to the rest position. In this arrangement, it is unnecessary to use pole pieces and/or mechanical stops of any kind in association with the armature and components attached thereto. Because there are no mechanical stops, noise associated with mechanical stops is eliminated along with the need for bumpers and/or pneumatic or viscous damping.

In the preferred form, the releasable shifter lock uses a cantilevered leaf spring and a control member placed in the path of travel of a blocker pin but pivotally mounted within the housing. The leaf spring is mechanically connected between a housing and the control member so that, when the leaf spring is in the relaxed position, the shifter lock is in the blocking condition and the solenoid armature is non-centered. Any movement of the armature in either direction flexes the spring. Energization of the coil draws the armature toward a centered position within the coil geometry, pushes on the control member, and flexes the leaf spring. Also in the preferred form, the magnetic portion of the armature which is mechanically connected to the control element is generally cylindrical but tapers from a central waistline of maximum diameter. This permits the armature to tilt within the coil bore without increasing contact area between the armature and the coil bobbin which has the effect of reducing binding and sliding noise between the armature and the bobbin.

According to another aspect of the invention, current to the coil of the electromagnetic device is cut off when the armature pivots the control member and the blocker pin is depressed. This is accomplished through the use of a lead frame mounted in substantial part to the inside surface of a housing member which also supports the control member. Contacts mounted on the blocker pin or a part which moves with the blocker pin are in sliding contact with the lead frame so as to make a coil energizing circuit when the blocker is in the extended position and break the coil energization circuit when the blocker is moved to the depressed position.

Other applications and aspects of the present invention will become apparent to those skilled in the art when the following description of the best mode contemplated for practicing the invention is read in conjunction with the accompanying drawing.

### BRIEF DESCRIPTION OF THE DRAWING

The description herein makes reference to the accompanying drawing wherein like reference numerals refer to like parts throughout the several views, and wherein:

FIG. 1 is a perspective view of a representative floor-mounted shifter mechanism in an automotive BTSI;

FIG. 2 is a plan view partly in section of a low-noise releasable shifter lock constructed in accordance with the present invention;

FIG. 3 is a perspective view of the shifter lock of FIG. 2 in a released or non-blocking condition;

FIG. 4 is a perspective view of the shifter lock of FIGS. 2 and 3 from the bottom side;

FIG. 5 is a perspective view of a slider-type contact used in the structure of FIGS. 2-4;

FIG. 6 is a plan view of a lead frame located in the structure of FIG. 3; and

FIG. 7 is a schematic circuit diagram of the BTSI circuit including the lead frame conductors and switch.

### DESCRIPTION OF THE PREFERRED EMBODIMENT

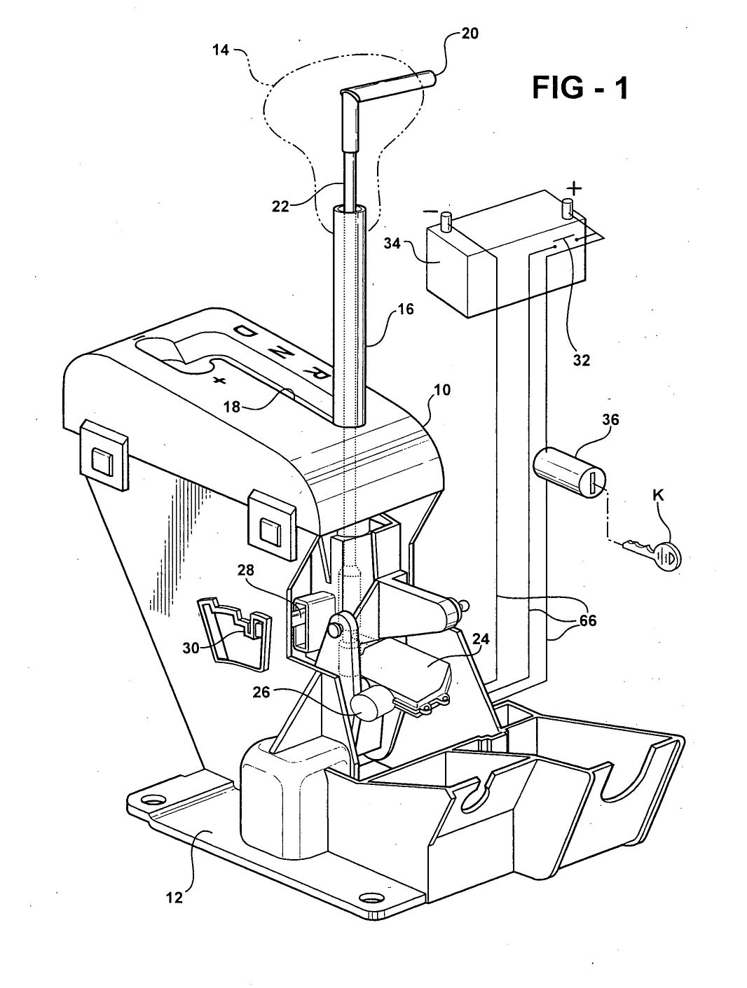

Referring first to FIG. 1, a conventional shifter mechanism 10 for automobiles equipped with automatic transmissions is shown to have a base 12 adapted to be secured to the interior floor of the vehicle where it can be conveniently reached by the operator of the vehicle. The shifter mechanism 10 comprises a shifter handle 14 connected to a pivotal shift lever 16 which can be manually manipulated to move within a slot 18 between positions corresponding to “PARK,” “REVERSE,” “NEUTRAL,” and “DRIVE.” The shift handle 14 is equipped with a side mounted push button 20 which, through a known mechanism, causes vertical movement of a shifter rod 22 extending down the center of lever 16 to move a bar 28 out of the “PARK” position in a detent 30 to permit free motion of the shift lever 16 in conventional fashion. The shifter lock 24 hereinafter described in detail prevents movement of the bar 28 out of the detent 30 until such time as the brake pedal (not shown) is depressed sufficiently to close a switch 32 associated with a circuit to the vehicle battery 34. The circuit may include a connection to an ignition key lock 36 as hereinafter described.

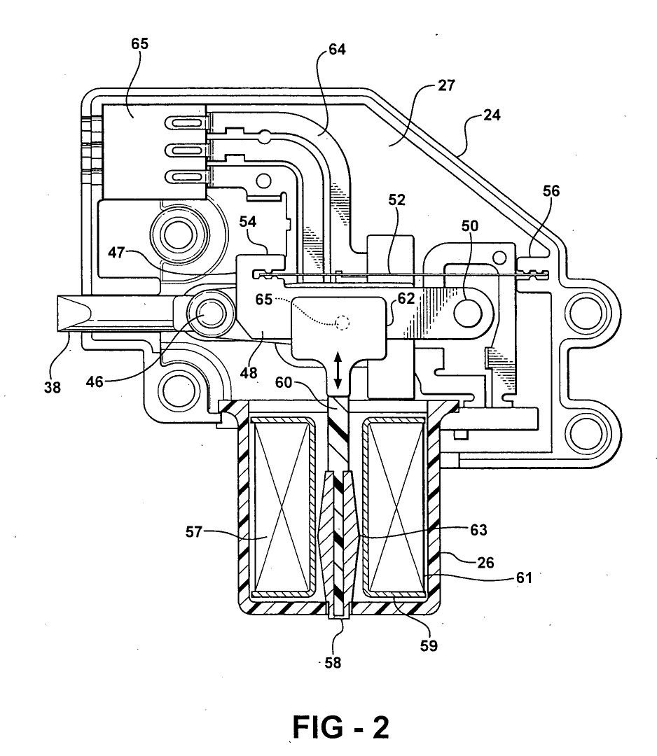

The circuit comprising the switch 32, the battery 34 and the ignition key lock 36 is connected by wires 66 to releasable shifter lock 24 having a two-part plastic case hereinafter described with reference to FIGS. 2-4. The plastic case has flat interior side surfaces 27 and carries an electromagnetic device in the form of a solenoid 26 the energization of which is controlled by the BTSI circuit in a manner hereinafter described.

Looking now to the additional figures, the shifter lock 24 includes a slidable blocker pin 38 which mechanically interferes with the shifter rod 22 when in the extended position shown in FIG. 2 to prevent vertical movement of the shifter rod 22 which would normally be produced by depressing the push button 20. This effectively locks the shift mechanism 10 in the “PARK” position shown in FIG. 1 and prevents movement of the shift lever 16 to other operating ranges until the operating conditions of the BTSI system are satisfied as hereinafter described.

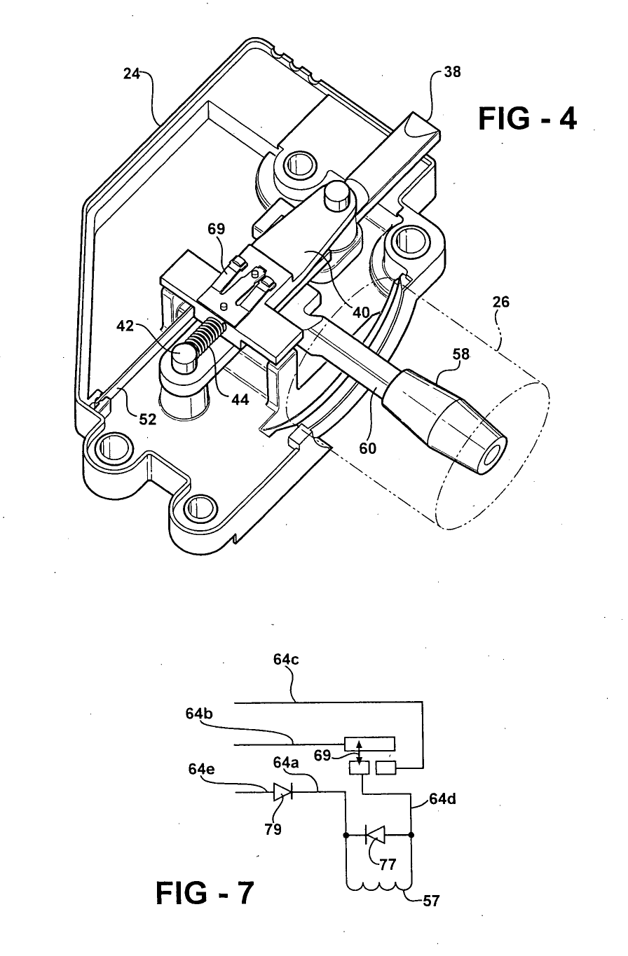

The blocker pin 38 is carried by a plastic slider 40 which extends toward a mechanical stop 42. A coil spring 44 is disposed between the end surface of the body and the mechanical stop 42 to provide a return bias to the extended position shown in FIGS. 2 and 4. An upwardly extending pin 46 on the slider 40 abuts a mitered end surface 47 of a control arm 48 pivotally connected to the housing 24 by means of a pivot pin 50. When the pin 46 abuts the surface 47, movement of the slider 40 and the blocker pin 38 from left to right as shown in FIG. 2 is not possible.

A metal leaf spring 52 is connected between clamping structure 54 on the control arm 48 and clamping structure 56 on the BTSI housing 24. When the control arm 48 is in the blocking position shown in FIG. 2, the leaf spring 52 is “relaxed”; i.e., it is not flexed either up or down to assert a biasing force on the control arm 48 or the armature of the solenoid 26.

Solenoid 26 includes a coil 57 mounted on a plastic bobbin 59 having a central bore 61 which accommodates a tapered ferritic armature 58 mounted on a plastic rod 60 having a head structure 62 which is pivotally pinned at 65 to a central position on the control arm 48. The armature 58 has a substantially centrally located “waistline” 63 of maximum diameter and tapers in both longitudinal directions from the waistline 63 and within the bobbin bore 61 as shown. When the control arm 48 is in the blocking position and the leaf spring 52 is in the relaxed position, the armature 58 is in a non-centered; i.e., below center, position relative to the geometry of the coil 57. Of course, the coil 57 of the solenoid 26 is not energized with DC current in this condition.

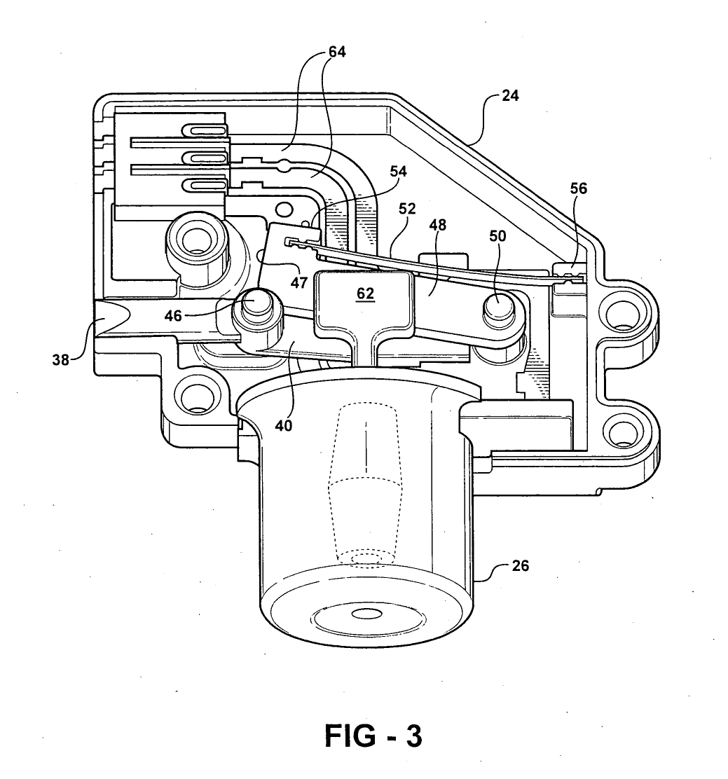

When the solenoid 26 is energized by directing current from the battery 34 through the coil 57, the electromagnetic force exerted by the flux pattern through the armature 58 tries to center the armature relative to the coil geometry by moving the armature 58 upwardly as shown in FIGS. 2 and 3. Through the connector rod 60 and the structure 62, the energization of the solenoid 26 raises the free end of the control arm 48 to unblock the pin 38 and allows the slider 40 to move from left to right as shown in FIGS. 2 and 3 when the push button 20 is depressed. Raising control arm 48 also has the effect of flexing the leaf spring 52, thus creating a bias force trying to return the armature 58 to the lowered, non-centered condition shown in FIG. 2.

Raising the left end of the control arm 48 to the position shown in FIG. 3 allows the blocker pin 38 to be depressed into the BTSI housing 24 by action of the push button 20. This, in turn, allows the rod 22 to move vertically downwardly in the structure of FIG. 1 removing the bar 28 from the detent 30 and permitting the shifter to be removed from the “PARK” position.

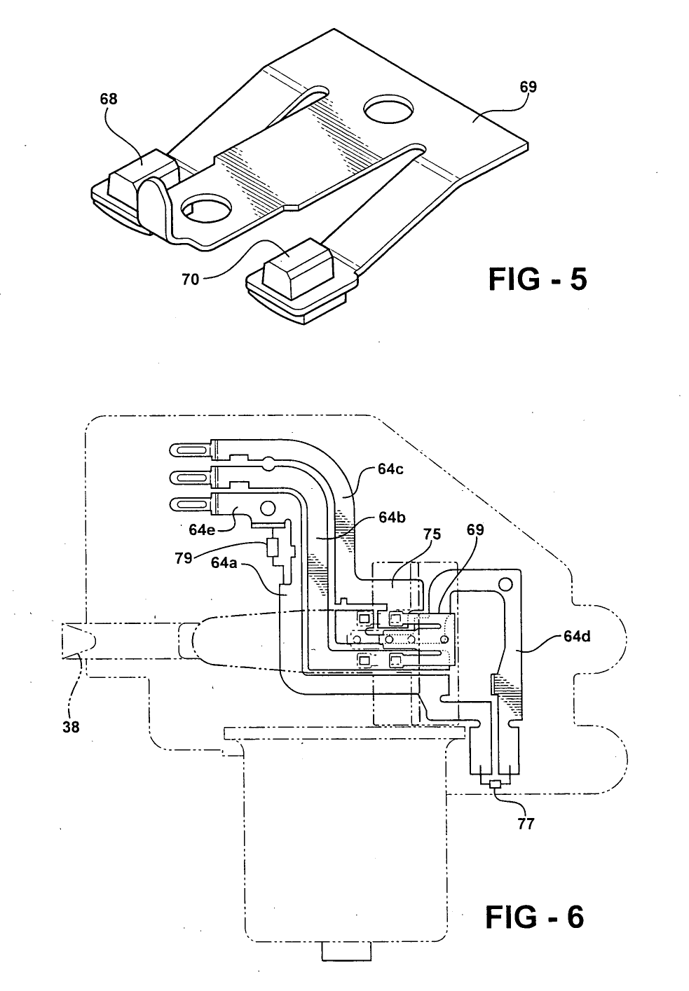

As shown in FIGS. 2, 3 and 5, a conductive lead frame 64 is fastened such as by heat staking to an inside surface of the BTSI housing 24 and connected between the solenoid coil 57 and the exterior wires 66 to complete the system shown in FIG. 1. The lead frame 64 is made from flat metal stock which is connected through port 65 to the wires 66. The lead frame 64 has separate conductors 64a, 64b, 64c, 64d and 64e of which 64a is connected to the solenoid coil 57, conductor 64b is ground and conductor 64c is connected to the ignition key lock 36. As shown in FIG. 6, there is a gap 75 between the inner ends of conductors 64b and 64d for switching purposes as hereinafter discussed. A spring metal conductor 69 with sliding contacts 68 and 70 forms part of a switch together with the lead frame conductors 64b, 64c and 64d shown in FIG. 6 to control the energization and deenergization of the solenoid coil 57 as well as to energize the ignition key lock 36 shown in FIG. 1. The switch conductor 69 is mounted on the bottom side of the slider 40 so as to move from left to right as shown in FIGS. 2 and 3 when the blocker pin 38 is depressed into the BTSI housing 24 by downward movement of the shifter rod 22. In the non-depressed condition, the contacts 68 and 70 engage conductors 64d and 64b in the lead frame 64 so as to complete a circuit from the battery 34 through the solenoid coil 57. A diode 77 bridges another gap in conductor 64a and 64d. When the blocker pin 38 is depressed so as to move slider 40 from left to right as shown in FIG. 6, the contacts 68 and 70 slide to the right, the upper contact moving across gap 75 between the conductors 64d and 64c in the lead frame 64 to break the circuit to the solenoid coil 57 thus deenergizing the solenoid 26, and to establish a circuit through the ignition key lock 36 to lock the ignition key in place so that it cannot be removed during normal operation of the vehicle. When the shift lever 16 is restored to the “PARK” position, the spring 52 moves the control arm 48 back to the blocking position as the pin 46 clears the end surface 47 allowing the device to return to the rest position shown in FIG. 2. The configuration of the switch portion of the lead frame 64 and the slider contact 69 can vary, the specific configuration shown being for illustration.

FIG. 7 shows the overall BTSI circuit in schematic style. All of the lead frame conductors 64a, 64b, 64c and 64d appear in the circuit of FIG. 7 along with the coil 57 and other conductors and circuit elements.

### Operation

In operation, a key K is inserted into the ignition key lock 36 and the vehicle placed in normal driving condition with the engine running. Shift lever 16 is in “PARK.” When the brake pedal (not shown) is depressed to close switch 32, a circuit from the battery 34 is completed through the coil 57 of the solenoid 26. This causes the armature 58 to move upwardly as shown in FIGS. 2 and 3 toward a centered position. It also raises the left or free end of the control arm 48 against the force of the leaf spring 52 until the pin 46 is no longer blocked by the end surface 47 of the control arm 48. Manual operation of the push button 20 thus allows the rod 22 to be depressed urging the blocker pin 38 and slider 40 from left to right as shown in FIG. 2. The system then assumes the condition shown in FIG. 3.

As soon as the contacts 68 and 70 of the switch stamping 69 move from left to right across the gap 75 in the lead frame 64, current to the solenoid coil 57 is switched off and current to the internal locking mechanism (not shown) of the conventional ignition key lock 36 is energized.

It can be seen that the arcuate or pivotal motion of the control arm 48 causes a pivotal connection 65 between the structure 62 and the control arm 48 to move in a slight arc. This causes the armature 58 to tip slightly within the coil bore 61. The reverse tapers on the armature 58 allow for this tilting without increasing the contact area between the outside surface of the armature 58 and the inside surface of the coil bore 61. This eliminates not only binding but also eliminates a significant source of noise during operation of the solenoid 26. Along with the fact that there are no mechanical stops associated with the armature, all major noise sources in the operation of the BTSI system have been eliminated.

Summarizing, the relaxed position of the system shown in FIG. 2 is characterized by these conditions:

(1) The control arm 48 is in the blocking position so as to prevent depression of the blocker pin 38; this in turn prevents the shifter rod 22 from being depressed to unlock the detent 30;

(2) The leaf spring 52 is in the relaxed condition; and

(3) The armature 58 is in a non-centered position relative to the coil 57.

When the solenoid 26 is energized, the armature 58 moves upwardly towards the centered position shown in FIG. 3 raising the control arm 48 to the unblocking condition and flexing the leaf spring 52. When the blocker pin 38 is pushed in by operation of the shift lever push button 20, the slider 40 moves from left to right as shown in FIGS. 2 and 3 and operates the sliding contact switch in the manner described above to deenergize the solenoid coil and energize the ignition coil. Systems with and without the ignition key lock are equally feasible. Urging the slider 40 toward the shifter unlocked condition compresses the coil spring 44 and creates a bias tending to urge the blocker pin from right to left as shown in FIG. 2. The leaf spring 52 eliminates the need for mechanical stops.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A low-noise releasable shifter lock for use in an automotive brake-shift interlock system of the type which requires a driver to depress a brake pedal before it is possible to shift a transmission out of the “PARK” condition, said shifter lock comprising:
a housing;
a blocker at least partially within the housing which, in a first position, prevents shifting and, in a second position, allows shifting;
a control member mounted within the housing and movable between a first position which prevents movement of the blocker from the first position to the second position and a second position which allows movement of the blocker from the first position to the second position;
a solenoid attached to the housing and having a coil;
an armature having a magnetic portion disposed within the coil so as to be affected by the energization thereof to move toward a magnetically centered position within the coil, said armature being mechanically connected to the control member; and
a leaf spring effectively connected between the housing and the control member such that, when in an unflexed condition, the control member is in the first position and the armature is in a magnetically non-centered position, said leaf spring being effective to resiliently resist movement of the control member from the first position when magnetic force acts on the armature and to return the control member to the first position when no magnetic force acts on the armature.

2. The shifter lock defined in claim 1 wherein the control member is mounted within the housing for pivotal movement.

3. The shifter lock defined in claim 1 wherein the magnetic portion of the armature is substantially cylindrical and has a longitudinal portion of maximum diameter and a compound tapered body which decreases in diameter as it extends in both directions from the maximum diameter position thereby to permit tilting of the magnetic portion of the armature within the solenoid coil.

4. The shifter lock defined in claim 1 further including a lead frame switch mounted within and to the housing for electrical connection to external components, said lead frame having a switch portion underlying the control member, said control member having slidable switch contacts disposed thereon which slidably electrically engage the underlying portions of the lead frame to perform switching operations when said control member moves from the first position to the second position and back.

5. The shifter lock defined in claim 1 further characterized by the absence of mechanical stops associated with the armature.

6. A releasable shifter lock for use in an automotive BTSI comprising:
a housing having an interior surface;
a blocker at least partially within the housing which, in a first position, prevents shifting and, in a second position, allows shifting;
a control member mounted within the housing and movable between a first position which prevents movement of the blocker from the first position to the second position and a second position which allows movement of the blocker from the first position to the second position;
a solenoid attached to the housing and having a coil;
an armature having a magnetic portion disposed within the coil so as to be affected by the energization thereof to move toward a magnetically centered position within the coil, said armature being mechanically connected to the control member;
a lead frame mounted to the interior surface and defining part of a circuit for energizing the solenoid; and
contacts mounted on the control member and in sliding contact with the lead frame for making the solenoid energizing circuit when the control member is in the first position and for breaking the energizing circuit when the control member is in the second position.

7. The shifter lock of claim 6 wherein the control member is mounted to the housing for pivotal movement.

8. The shifter lock of claim 7 further including a leaf spring mounted on the housing and connected to the control member.

9. A releasable shifter lock for use in automotive brake shift interlock systems comprising:
a housing having an interior surface;
a blocker member mounted within the housing for movement between a first position which locks an associated shifter and a second position which releases an associated shifter;
a solenoid comprising an actuator rod which extends from the solenoid into the housing when the solenoid is energized;
a lead frame comprising flat stock conductors mounted on said interior surface; and
a switch including a sliding contact member mounted on said blocker member and engaging the lead frame conductors for controlling the energization and deenergization of the solenoid according to the position of the blocker member.

10. In a shifter lock for use in an automotive brake-shift interlock system:
a housing;
a blocker structure movable within the housing;
a solenoid having an armature;
a connection between the armature and the blocker structure; and
a leaf spring connected between the housing and the blocker structure to place the blocker structure and the armature in a rest position when unflexed.

11. The shifter lock of claim 10 further including a lead frame comprising multiple flat stock conductors mounted in the housing proximate the blocker structure, and a contact element on the blocker structure and contacting the lead frame to perform a switching function when the blocker structure is moved.
